(19) United States
(12) Patent Application Publication
(10) Pub. No.: US 2026/0086306 A1
(43) Pub. Date: Mar. 26, 2026

(54) TEMPERATURE CONTROL DEVICE FOR OPTICAL MODULATORS, AND OPTICAL LINK DEVICE INCLUDING SAME

(71) Applicants: SAMSUNG ELECTRONICS CO., LTD., Suwon-si (KR); UIF (University Industry Foundation), Yonsei University, Seoul (KR)

(72) Inventors: Kiho KONG, Suwon-si (KR); Wooyoung CHOI, Seoul (KR); Daewon RHO, Seoul (KR); Jaekoo PARK, Seoul (KR)

(73) Assignees: SAMSUNG ELECTRONICS CO., LTD., Suwon-si (KR); UIF (University Industry Foundation), Yonsei University, Seoul (KR)

(21) Appl. No.: 19/323,483

(22) Filed: Sep. 9, 2025

(30) Foreign Application Priority Data
Sep. 24, 2024 (KR) 10-2024-0129429

(51) Int. Cl. G02B 6/42; H04B 10/50; H04B 10/61

(52) U.S. Cl. CPC G02B 6/4266; H04B 10/50572; H04B 10/61

(57) ABSTRACT

Provided is a method of controlling a temperature of an optical modulator including a first operation including repeatedly inputting a first input signal and a second input signal to the optical modulator, inputting a heater control value to the optical modulator, and obtaining an optimal heater control value at which a difference between a first output signal output corresponding to the first input signal and a second output signal output corresponding to the second input signal is maximized, a second operation including controlling the heater using the optimal heater control value, and inputting a third input signal to the optical modulator to set a third output signal corresponding to the third input signal as a reference value, and a third operation including feedback-controlling the heater control value so that a fourth output signal corresponding to a fourth input signal input to the optical modulator corresponds to the reference value.

### CROSS-REFERENCE TO RELATED APPLICATION

This application claims priority to Korean Patent Application No. 10-2024-0129429, filed on Sep. 24, 2024, in the Korean Intellectual Property Office, the disclosure of which is incorporated by reference herein in its entirety.

### BACKGROUND

### 1. Field

One or more embodiments of the disclosure relate to a temperature control device for optical modulators, and an optical link device including the temperature control device.

### 2. Description of the Related Art

With the recent advancement of Internet technology, not only large-scale data centers but also relatively small and medium-sized data centers are rapidly increasing, leading to a significant increase in the demand for relatively large-capacity optical communication interconnects. In particular, the necessity for optical communication systems for relatively short and medium distances, such as 2 km, 500 m, and 100 m, as well as relatively long-distance transmissions of more than 10 km, is increasing.

Silicon photonics technology of integrating all optical components onto a single substrate or different types of substrates, based on silicon, may be used for such relatively small and medium-sized short-distance optical communication systems.

To complete an optical communication interconnect, an optical modulator that converts an electrical signal into an optical signal is required at the transmitter. Among optical modulators, ring-type modulators are relatively small in size, may be used for wavelength division multiplexing (WDM), and may be used for relatively high-speed communications. However, as the characteristic curve of these optical modulators changes according to temperature, the quality of communication data deteriorates. Therefore, a temperature control device is required to control the temperature of an optical modulator.

### SUMMARY

One or more embodiments provide control of the temperature of an optical modulator in conjunction with a heater included in the optical modulator so that the optical modulator has a maximal optical modulation amplitude (OMA).

According to an aspect of one or more embodiments, there is provided a method of controlling a temperature of an optical modulator in including a heater, the method including a first operation including repeatedly inputting a first input signal and a second input signal to the optical modulator, inputting a heater control value to the optical modulator by sweeping the heater control value within a preset range, and obtaining an optimal heater control value at which a difference between a first output signal output from the optical modulator corresponding to the first input signal and a second output signal output from the optical modulator corresponding to the second input signal is maximized, a second operation including controlling the heater using the optimal heater control value, and inputting a third input signal to the optical modulator to set a third output signal corresponding to the third input signal as a reference value, and a third operation including feedback-controlling the heater control value so that a fourth output signal corresponding to a fourth input signal input to the optical modulator follows the reference value.

The first input signal and the second input signal may be digital signals each having N bits, where N is an even number, and a number of transition of the first input signal and a number of transition of the second input signal may be N/2.

The third input signal may be a digital signal having N bits, where N is an even number, and a proportion of 1 included in the third input signal and a proportion of 0 included in the third input signal may be 50%.

The method may further include, in the third operation, performing proportional-integral-differential (PID) control is by combining the reference value with the fourth output signal, and adjusting the heater control value based on a result of the PID control.

The method may further include, in the third operation, performing dithering on the heater control value.

According to another aspect of one or more embodiments, there is provided a device configured to control a temperature of an optical modulator including a heater, the device including a processor configured to obtain an optimal heater control value at which optical modulation amplitude (OMA) of the optical modulator is maximized, control the heater using the optimal heater control value, input a third input signal to the optical modulator to set a third output signal corresponding to the third input signal as a reference value, and feedback-control the optimal heater control value so that a fourth output signal corresponding to a fourth input signal input to the optical modulator follows the reference value.

The processor may be further configured to repeatedly input a first input signal and a second input signal to the optical modulator, input a heater control value by sweeping within a preset range to the optical modulator, and obtain, as the optimal heater control value, a heater control value at which a difference between a first output signal output from the optical modulator corresponding to the first input signal and a second output signal output from the optical modulator corresponding to the second input signal is maximized.

The first input signal and the second input signal may be digital signals having N bits, where N is an even number, and a number of transition of the first input signal and a number of transition of the second input signal may be N/2.

The third input signal may be a digital signal having N bits, where N is an even number, and a proportion of 1 included in the third input signal and a proportion of 0 included in the third input signal may be 50%.

The processor may be further configured to perform proportional-integral-differential (PID) control by combining the reference value with the fourth output signal, and adjust the heater control value based on a result of the PID control.

The processor may be further configured to perform dithering on the heater control value.

The device may further include a photodiode configured to convert an optical signal modulated by the optical modulator into an electrical signal and output the electrical signal.

The device may further include a low pass filter (LPF) configured to filter a signal of a frequency less than or equal to a cutoff frequency by attenuating a signal of a frequency equal to or greater than the cutoff frequency, with respect to the electrical signal obtained by the photodiode.

According to still another aspect of one or more embodiments, there is provided an optical link device including a laser configured to output a first optical signal, an optical transmitter configured to receive the first optical signal output by the laser and transmit a modulated second optical signal, an optical receiver configured to receive the modulated second optical signal from the optical transmitter and restore data included in the modulated second optical signal to perform an optical link, and an optical fiber portion between the optical transmitter and the optical receiver to transmit the modulated second optical signal from the optical transmitter to the optical receiver, wherein the optical transmitter includes an optical modulator including a heater and configured to modulate the first optical signal into the modulated second optical signal including the data, and a temperature control device configured to obtain an optimal heater control value at which optical modulation amplitude (OMA) of the optical modulator is maximized, control the heater using the optimal heater control value, input a third input signal to the optical modulator to set a third output signal corresponding to the third input signal as a reference value, and feedback-control the heater control value so that a fourth output signal corresponding to a fourth input signal input to the optical modulator follows the reference value.

The optical transmitter may include a driver configured to input data to the optical modulator, and a high pass filter configured to filter a signal of a frequency equal to or greater than a cutoff frequency by attenuating a signal of a frequency equal to or less than the cutoff frequency, with respect to data output by the driver.

The temperature control device may be further configured to repeatedly input a first input signal and a second input signal to the optical modulator, input a heater control value by sweeping within a preset range to the optical modulator, and obtain, as the optimal heater control value, a heater control value at which a difference between a first output signal output from the optical modulator corresponding to the first input signal and a second output signal output from the optical modulator corresponding to the second input signal is maximized.

The first input signal and the second input signal may be digital signals having N bits, where N is an even number, and a number of transition of the first input signal and a number of transition of the second input signal may be N/2.

The third input signal may be a digital signal having N bits, where N is an even number, and a proportion of 1 included in the third input signal and a proportion of 0 included in the third input signal may be 50%.

The temperature control device may be further configured to perform proportional-integral-differential (PID) control by combining the reference value with the fourth output signal, and adjust the heater control value based on a result of the PID control.

The temperature control device may be further configured to perform dithering on the heater control value.

### BRIEF DESCRIPTION OF DRAWINGS

The above and other aspects, features, and advantages of certain embodiments of the inventive concept will be more apparent from the following description taken in conjunction with the accompanying drawings, in which:

FIG. 1 is an example diagram showing a characteristic curve according to changes in temperature of an optical modulator;

FIG. 2 is a block diagram of a structure of an optical link device according to one or more embodiments;

FIG. 3 is a block diagram of a temperature control device for an optical modulator, according to one or more embodiments;

FIG. 4 is a flowchart of a method of controlling a temperature of the optical modulator, according to one or more embodiments;

FIG. 5 is a graph for explaining a principle of setting an optical heater control value;

FIG. 6 is a flowchart of dithering according to one or more embodiments; and

FIG. 7 is a graph regarding results of simulation using a temperature control device, according to one or more embodiments.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Although general terms widely used at present were selected for describing the present disclosure in consideration of the functions thereof, these general terms may vary according to intentions of one of ordinary skill in the art, case precedents, the advent of new technologies, or the like. Terms arbitrarily selected by the applicant of the disclosure may also be used in a specific case. In this case, their meanings need to be given in the detailed description. Hence, the terms must be defined based on their meanings and the contents of the entire specification, not by simply stating the terms.

Throughout the descriptions of embodiments, when an element is referred to as being “connected” or “coupled” to another element, it can be directly connected or coupled to the other element, or can be electrically connected or coupled to the other element with intervening elements interposed therebetween. The terms “comprises” and/or “comprising” or “includes” and/or “including” when used in this specification, specify the presence of stated elements, but do not preclude the presence or addition of one or more other elements.

Terms “configured” or “include” used herein should not be construed as necessary including all of several components or several steps written in the disclosure, but as not including some of the components or steps or as further including additional components or steps.

While such terms as “first”, “second”, etc., may be used to describe various components, such components must not be limited to the above terms. The above terms are used only to distinguish one component from another.

The descriptions of embodiments below should not be construed as limiting the right scope of the accompanying claims, and it should be construed that all of the technical ideas included within the scope equivalent to the claims are included within the right scope of embodiments. Embodiments of the disclosure will now be described more fully with reference to the accompanying drawings.

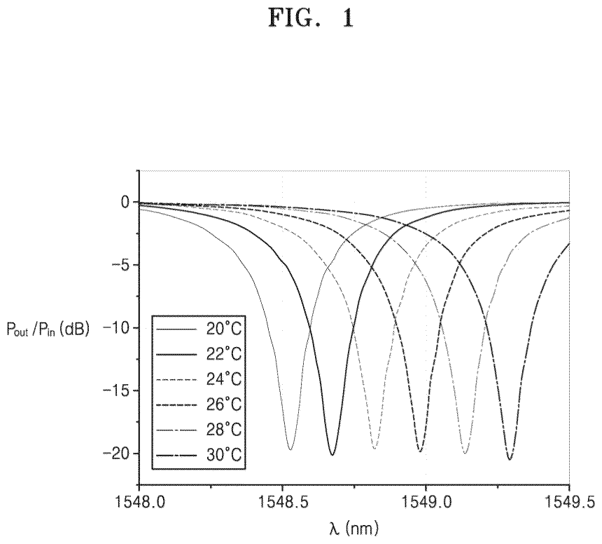

FIG. 1 is an example diagram showing a characteristic curve according to changes in temperature of an optical modulator according to related art.

Referring to FIG. 1, graphs illustrating how Pₒᵤₜ/Pᵢₙ of the optical modulator changes according to different temperatures as the wavelength of light changes is shown. As the characteristic curve of these optical modulators changes according to temperature, the quality of communication data may deteriorate.

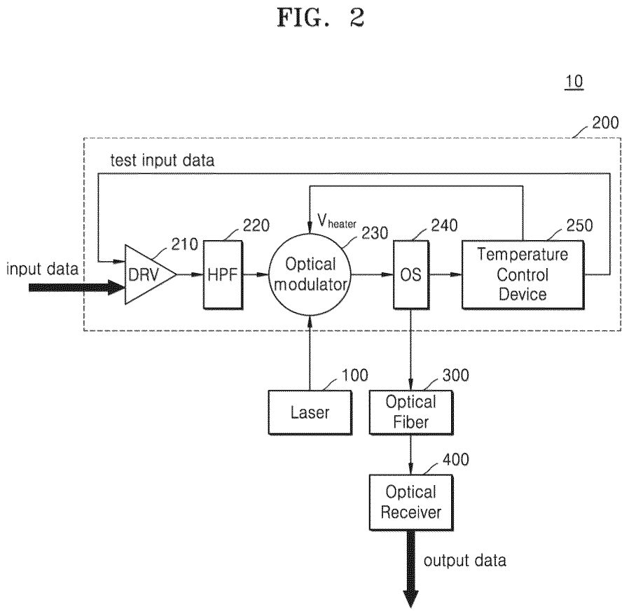

FIG. 2 is a block diagram of a structure of an optical link device 10 according to one or more embodiments.

Referring to FIG. 2, the optical link device 10 according to one or more embodiments is an optical communication system of an external modulation type, and thus is price competitive and may reduce power consumption in a relatively short-distance and medium-distance, large-capacity optical communication system. The optical link device 10 reduces a chip area through integration based on silicon and may implement a low-cost optical link. The optical link device 10 includes a laser 100, an optical transmitter 200, an optical fiber 300, and an optical receiver 400.

The laser 100 outputs a first optical signal that is a continuous wave (CW) laser 100. The first optical signal is a CW laser 100 for a wavelength necessary for an optical modulator which will be described below. The laser 100 outputs light in a band of 1300 nm to 1600 nm. The laser 100 may output light in a 1550 nm band, but may output a 1310 nm band to increase the efficiency of wavelength distribution in a relatively short-distance and medium-distance optical communication system.

The optical transmitter 200 receives the first optical signal from the laser 100, modulates the first optical signal into a second optical signal including data, and transmits the modulated second optical signal. The optical transmitter 200 may be integrated based on silicon. At this time, as the optical transmitter 200 is integrated at a chip level, the reliability of electrical signal connection may be secured.

The optical transmitter 200 includes a driver 210, a high-pass filter (HPF) 220, an optical modulator 230, an optical splitter 240, and a temperature control device 250.

The driver 210 receives input data from the outside of the optical link device 10, and inputs the received input data to the optical modulator 230. For example, the driver 210 enables the optical modulator 230 to be driven. According to one or more embodiments, the driver 210 may also receive test input data from the temperature control device 250.

The HPF 220 may filter out a signal of a frequency equal to or greater than a cutoff frequency by attenuating a signal of a frequency equal to or less than the cutoff frequency, with respect to data output by the driver 210.

The optical modulator 230 receives a first optical signal from the laser 100, receives the data from the driver 210, and modulates the first optical signal into the second optical signal including the data. For example, the optical modulator 230 adds the data to the first optical signal and modulates the first optical signal into the second optical signal. The optical modulator 230 may be implemented as a microring modulator (MRM) including a micro ring having a diameter of 10 μm to 30 μm. As described above, as the characteristic curve of the optical modulator 230 changes according to temperature as shown in FIG. 1, the optical modulator 230 may degrade the quality of communication data.

The optical modulator 230 may include a heater composed of a resistor in order to control the temperature of the optical modulator 230. The heater may receive a heater control voltage from the temperature control device 250, and may operate according to the heater control voltage.

The optical splitter 240 may distribute a portion of an output of the optical modulator 230. The portion of the output of the optical modulator 230 may be transmitted to the temperature control device 250 by the optical splitter 240, and a remaining portion of the output of the optical modulator 230 may be transmitted to an optical fiber by the optical splitter 240.

The temperature control device 250 may control the temperature of the optical modulator 230 in conjunction with the heater included in the optical modulator 230. The temperature control device 250 may control an operation of the heater by transmitting a heater control voltage Vₕₑₐₜₑᵣ to the heater. The temperature control device 250 may control the operation of the heater so that an optical modulation amplitude (OMA) of the optical modulator 230 is maximized.

The optical fiber 300 is placed between the optical transmitter 200 and the optical receiver 400 and transmits the second optical signal from the optical transmitter 200 to the optical receiver 400. The optical fiber 300 may use single-mode fiber (SMF) to secure a transmission distance. Optical connection between the optical transmitter 200, the optical fiber 300, and the optical receiver 400 is performed through an optical coupler.

The optical receiver 400 receives the second optical signal from the optical transmitter 200, and may restore the data included in the second optical signal to perform an optical link. The optical receiver 400 may be integrated based on silicon to be formed at chip level. At this time, as the optical receiver 400 is integrated at the chip level, the reliability of electrical signal connections may be secured.

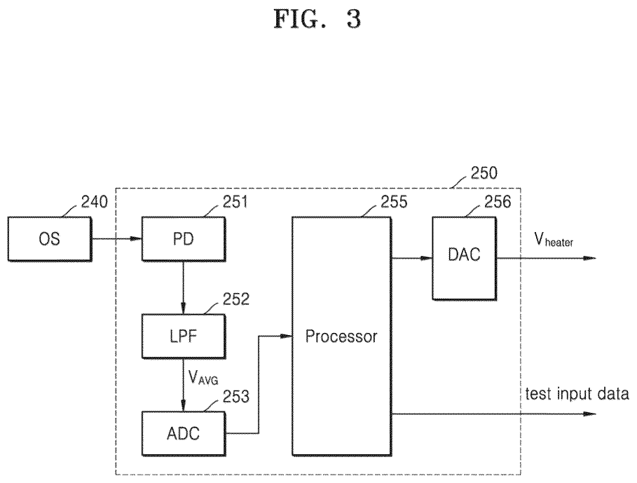

FIG. 3 is a block diagram of the temperature control device 250 for an optical modulator, according to one or more embodiments.

The temperature control device 250 according to one or more embodiments includes a photo diode (PD) 251, a low-pass filter (LPF) 252, an analog-to-digital converter (ADC) 253, a processor 255, and a digital-to-analog converter (DAC) 256.

The PD 251 transforms an optical signal into an electrical signal and outputs the electrical signal. The PD 251 may convert some output data received from the optical modulator 230 through the optical splitter 240 into an electrical signal.

The LPF 252 may only filter out the signal of the frequency less than or equal to the cutoff frequency by attenuating the signal of the frequency equal to or greater than the cutoff frequency, with respect to the electrical signal obtained by the PD 251. The LPF 252 may output an electrical signal (e.g., an average voltage V_{AVG}) corresponding to an average of the electrical signal obtained by the PD 251.

The ADC 253 may convert an analog electrical signal (e.g., the average voltage V_{AVG}) output by the LPF 252 into a digital electrical signal, and may output the digital electrical signal.

The processor 250 may operate in a calibration mode to search for and obtain an optimal heater control value at which the OMA of the optical modulator 230 is maximized. The processor 255 inputs a test pattern signal to the optical modulator 230 in the calibration mode, controls the heater control value, and performs test heater control. For example, the processor 255 repeatedly inputs the test pattern signal to the optical modulator 230 in the calibration mode, and inputs the heater control value to the optical modulator 230 by sweeping the heater control value within a preset range, to thereby search for and obtain an optimal heater control value at which the OMA of the optical modulator 230 is maximized.

The processor 255 may repeatedly input, to the optical modulator 230, a test pattern signal in which the first input signal and the second input signal are repeated, in the calibration mode. The first input signal and the second input signal are digital signals each having N bits.

When the first input signal or the second input signal uses a pattern whose value does not change (e.g., 1111), the value may be blocked by the HPF 220 connected to a rear end of the driver 210, and no significant change in an operation of the optical modulator 230 due to the test pattern signal may be detected. In addition, a purpose of inputting the test pattern signal in a calibration mode operation is to search for and obtain the optimal heater control value at which the OMA of the optical modulator 230 is maximized. When the optical modulator 230 performs an operation of the optical transmitter 200, the input data received through the driver 210 is random data having an arbitrary value. When the random data is input to the optical modulator 230, dynamic heating may occur. Therefore, the optimal heater control value of the optical modulator 230 obtained using the test pattern signal having the pattern whose value does not change (e.g., 1111) may not be the heater control value at which the OMA is maximized in a situation where the random data is input to the optical modulator 230. As a result, the first input signal or the second input signal may use a pattern with changing values (e.g., 1101 or 1100).

The number of transitions in each of the first input signal and the second input signal may be N/2. A transition refers to the first input signal or second input signal of N bits changing from 1 to 0 or from 0 to 1.

When the optical modulator 230 performs the function of the optical transmitter 200, the input data received through the driver 210 is random data having N bits, and the number of transitions is N/2 on average. The optimal heater control value at which the OMA of the optical modulator 230 is maximized may be changed due to the effect of dynamic heating according to the number of transitions. Therefore, in order to prevent the optimal heater control value from changing due to the dynamic heating effect of the optical modulator 230, each of the first input signal and the second input signal received as the test pattern signal have a number of transitions equal to N/2.

The processor 255 may determine, as the optimal heater control value, a heater control value at which a difference between a first output signal for the first input signal and a second output signal for the second input signal is maximized, based on optical modulation characteristics of the optical modulator 230 being linear.

For example, when the first input signal is 1110 and the second input signal is 0001, the first output signal may be V_{AVG_1110} and the second output signal may be V_{AVG_0001}. Ratios of “1” to the first input signal and the second input signal may be 75% and 25%, respectively. Based on the optical modulation characteristics of the optical modulator 230 being linear, the first output signal and the second output signal represent values corresponding to 75% and 25% of an optical modulation level, respectively. Accordingly, the difference between the first output signal and the second output signal becomes a value representing 50% of the OMA. As a result, the heater control value at which the difference between the first output signal and the second output signal is maximized becomes the optimal heater control value at which the OMA of the optical modulator 230 is maximized.

Thereafter, the processor 255 determines the optimal heater control value in the calibration mode, and then sets a reference value, based on the optimal heater control value.

The processor 255 may control a heater operation of the optical modulator 230 by using the optimal heater control value determined in the calibration mode, and may input a third input signal to the optical modulator 230 to set a third output signal for the third input signal as the reference value. When the optical modulator 230 performs the operation of the optical transmitter 200, the input data received through the driver 210 is random data having N bits, and a ration between 1 and 0 is 1:1 on average. Therefore, the third input signal may be a digital signal having N bits (where N is an even number), and percentages of 1 and 0 may be each set to be 50%. For example, the third input signal may be 1100 when N is 4.

The optical modulator 230 may be affected by external temperature. Accordingly, when the optimal heater control value determined in the calibration mode is fixed and used, the OMA of the optical modulator 230 may decrease due to the influence of an external temperature of the optical modulator 230. Therefore, the processor 255 needs to operate in a tracking mode of feedback-controlling the heater control value so that a fourth output signal for any fourth input signal input to the optical modulator 230 follows the reference value, after setting the reference value. The fourth input signal is random data with N bits, the number of transitions may be N/2 on average, and the ratio of 1 to 0 may be 1:1 on average.

According to one or more embodiments, the processor 255 may perform proportional-integral-differential (PID) control by combining the reference value with the fourth output signal in the following mode, and may adjust the heater control value according to a PID result. The PID control is a structure that measures the fourth output signal, which is an output value of a target that is to be controlled, calculates (obtains) an error by comparing a result of the measurement with the reference value, and calculates (obtains) and feedbacks a control value for reducing the error.

According to one or more embodiments, the processor 255 may perform dithering on the heater control value in the following mode to adjust the heater control value so that the fourth output signal follows and corresponds to the reference value.

The DAC 256 may convert a digital heater control value generated by the processor 255 into an analog electrical signal and output the analog electrical signal. An analog heater control value output by the DAC 256 may be transmitted to the optical modulator 230 so that an operation of the heater of the optical modulator 230 may be controlled.

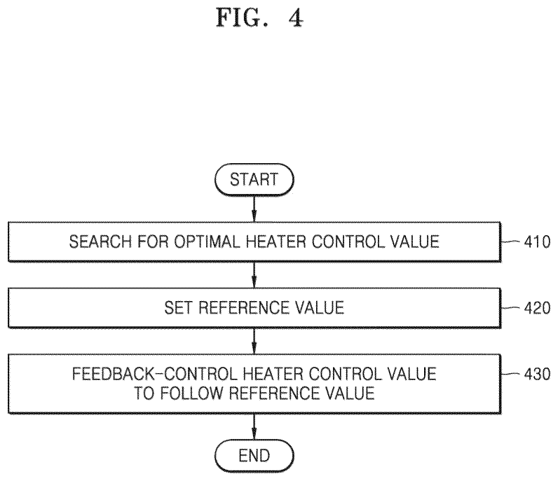

FIG. 4 is a flowchart of a method of controlling a temperature of the optical modulator 230, according to one or more embodiments.

Referring to FIGS. 2 through 4, the method of controlling the temperature of the optical modulator 230, according to one or more embodiments, includes a first operation 410 in which the temperature control device 250 operates in the calibration mode to search for and obtain the optimal heater control value at which the OMA of the optical modulator 230 is maximized, a second operation 420 in which the temperature control device 250 sets the reference value, and a third operation 430 in which the temperature control device 250 feedback-controls the heater control value to follow the reference value.

For example, in the first operation 410, the temperature control device 250 repeatedly inputs the test pattern signal to the optical modulator 230, and inputs the heater control value to the optical modulator 230 by sweeping the heater control value within a preset range, to thereby search for and obtain the optimal heater control value at which the OMA of the optical modulator 230 is maximized.

The temperature control device 250 may repeatedly input, to the optical modulator 230, the test pattern signal in which the first input signal and the second input signal are repeated. The first input signal and the second input signal are digital signals each having N bits. The first input signal or the second input signal may use a pattern with changing values (e.g., 1101 or 1100).

The number of transitions in each of the first input signal and the second input signal may be N/2. The transition refers to the first input signal or second input signal of N bits changing from 1 to 0 or from 0 to 1.

The temperature control device 250 may determine, as the optimal heater control value, a heater control value at which a difference between a first output signal for the first input signal and a second output signal for the second input signal is maximized, based on optical modulation characteristics of the optical modulator 230 being linear.

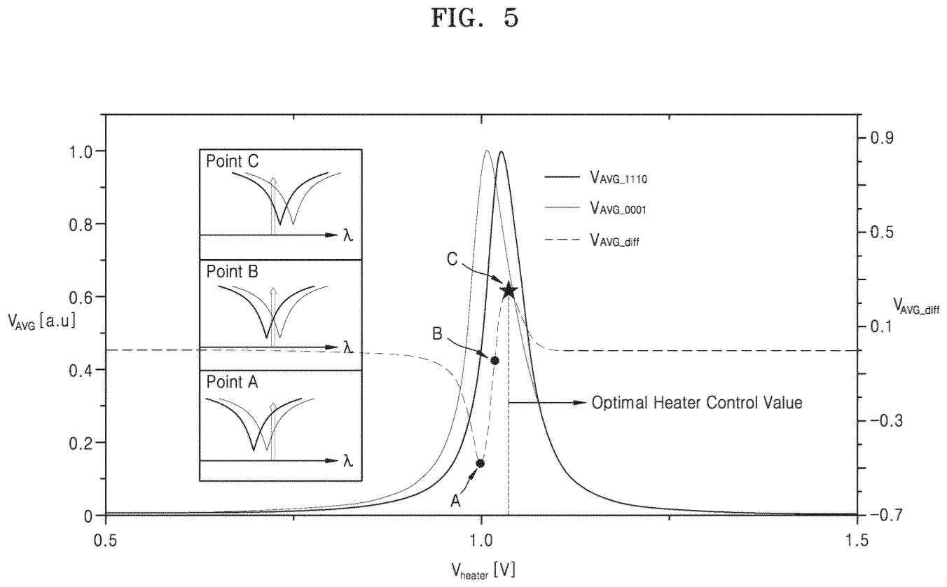

A principle of setting the optimal heater control value will be explained with reference to FIG. 5. A left vertical axis represents the first output signal and the second output signal. A right vertical axis represents V_{AVG_diff}, which is the difference between the first output signal and the second output signal. A horizontal axis represents a heater control value Vₕₑₐₜₑᵣ. The units of the vertical axes are arbitrary units (au) When the first input signal is 1110 and the second input signal is 0001, the first output signal may be V_{AVG_1110} and the second output signal may be V_{AVG_0001}. Ratios of 1 to the first input signal and the second input signal may be 75% and 25%, respectively. Based on the optical modulation characteristics of the optical modulator 230 being linear, the first output signal and the second output signal represent values corresponding to 75% and 25% of an optical modulation level, respectively. Accordingly, V_{AVG_diff}, which is the difference between the first output signal and the second output signal, becomes a value representing 50% of the OMA.

The temperature control device 250 repeatedly inputs a first input signal (i.e., 1110) and a second input signal (i.e., 0001), which are test pattern signals, to the optical modulator 230, and inputs a heater control value to the optical modulator 230 by sweeping the heater control value within a preset range, to thereby search for and obtain a heater control value at which the difference between the first output signal and the second output signal, V_{AVG_diff}, is maximized. Referring to FIG. 5, a heater control value at which the difference between the first output signal and the second output signal, V_{AVG_diff}, becomes maximum is point C, and, when the heater control value is point C, the OMA of the optical modulator 230 becomes maximum. As a result, the temperature control device 250 determines the heater control value of point C as the optimal heater control value.

Referring back to FIG. 4, in the second operation 420, the temperature control device 250 sets the reference value, based on the optimal heater control value, after determining the optimal heater control value in the calibration mode. The temperature control device 250 may control a heater operation of the optical modulator 230 by using the optimal heater control value determined in the calibration mode, and may input a third input signal to the optical modulator 230 to set a third output signal for the third input signal as the reference value. The third input signal may be a digital signal having N bits (where N is an even number), and percentages of 1 and 0 may be each set to be 50%. For example, the third input signal may be 1100 when N is 4.

In the third operation 430, the temperature control device 250 operates in a tracking mode of feedback-controlling the heater control value so that a fourth output signal for any fourth input signal input to the optical modulator 230 follows and corresponds to the reference value. The fourth input signal is random data with N bits, the number of transitions may be N/2 on average, and the ratio of 1 to 0 may be 1:1 on average.

According to one or more embodiments, the temperature control device 250 may perform PID control by combining the reference value with the fourth output signal in the following mode, and may adjust the heater control value according to a PID result. The PID control is a structure that measures the fourth output signal, which is an output value of a target that is to be controlled, calculates (obtains) an error by comparing a result of the measurement with the reference value, and calculates (obtains) and feedbacks a control value for reducing the error.

According to one or more embodiments, the temperature control device 250 may perform dithering on the heater control value in the following mode to adjust the heater control value so that the fourth output signal follows and corresponds to the reference value.

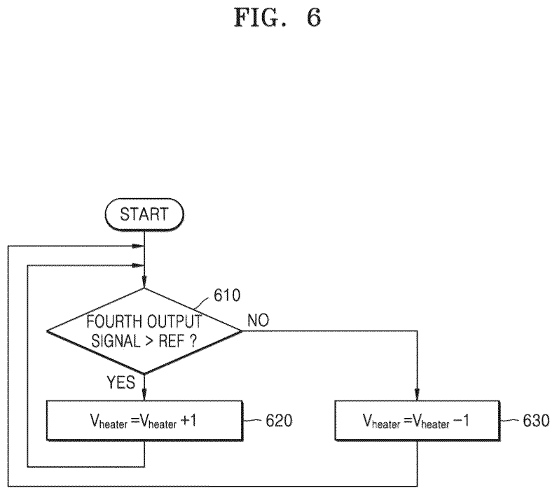

Referring to FIG. 6 illustrating performance of dithering, in operation 610, the temperature control device 250 compares the fourth output signal with a reference value REF. When the fourth output signal is greater than the reference value REF, the temperature control device 250 increases the heater control value Vₕₑₐₜₑᵣ by 1 level, in operation 620. When the fourth output signal is less than or equal to the reference value REF, the temperature control device 250 decreases the heater control value Vₕₑₐₜₑᵣ by 1 level, in operation 630.

As a result, the temperature control device 250 may adjust the heater control value Vₕₑₐₜₑᵣ so that the fourth output signal follows and corresponds to the reference value REF, by performing dithering on the heater control value Vₕₑₐₜₑᵣ even when the optical modulator 230 is affected by an external temperature, thereby operating the optical modulator 230 so that the OMA of the optical modulator 230 is maximized.

The method of controlling the temperature of the optical modulator 230 may be recorded in a computer readable storage medium having embodied thereon at least one program including instructions for performing the method. Examples of the computer-readable recording medium include a magnetic medium such as a hard disk, a floppy disk, or a magnetic tape, an optical medium such as a compact disk-read-only memory (CD-ROM) or a digital versatile disk (DVD), a magneto-optical medium such as a floptical disk, and a hardware device specially configured to store and execute program commands such as a ROM, a random-access memory (RAM), or a flash memory. Examples of the program commands are high-level language codes that can be executed by a computer by using an interpreter or the like as well as machine language codes made by a compiler.

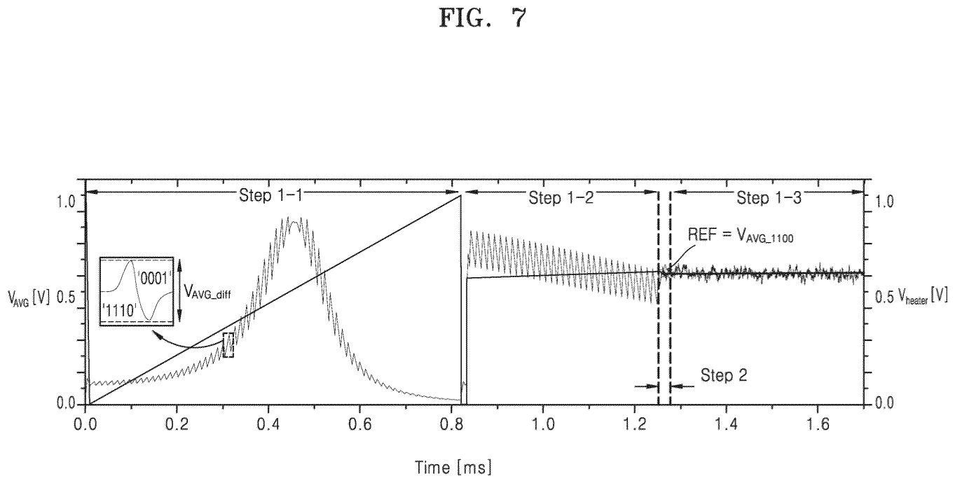

FIG. 7 is a graph regarding results of simulation using the temperature control device 250 according to one or more embodiments. A right vertical axis represents the first output signal and the second output signal V_{AVG}. A left vertical axis represents a heater control value Vₕₑₐₜₑᵣ.

Referring to FIGS. 2 through 6, in the first operation 410 in which the temperature control device 250 operates in the calibration mode to search for and obtain the optimal heater control value at which the OMA of the optical modulator 230 is maximized, the temperature control device 250 repeatedly inputs the test pattern signals 1110 and 0001 to the optical modulator 230, and inputs the heater control value to the optical modulator 230 by sweeping the heater control value within a preset range, to thereby search for and obtain the optimal heater control value at which the OMA of the optical modulator 230 is maximized. For example, the temperature control device 250 searches for the heater control value Vₕₑₐₜₑᵣ at which V_{AVG_diff} becomes maximum. The first stage 410 may be subdivided into a first-1 stage of a coarse sweep, and a first-2 stage of a fine sweep. As illustrated in FIG. 7, it may be seen that the V_{AVG} value changes while test pattern signals are being repeatedly input, and that the optimal heater control value Vₕₑₐₜₑᵣ is determined to be a point where a difference between the two values, V_{AVG-_diff}, is the greatest.

The temperature control device 250 controls the heater operation of the optical modulator 230 by using the optimal heater control value determined in the first operation 410, and inputs a third input signal 1100 to the optical modulator 230 to set a third output signal V_{AVG_1100} for the third input signal as the reference value.

Thereafter, the temperature control device 250 operates in a tracking mode of feedback-controlling the heater control value Vₕₑₐₜₑᵣ so that a fourth output signal V_{AVG} for any fourth input signal input to the optical modulator 230 follows and corresponds to the reference value.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and their equivalents.

What is claimed is:

1. A method of controlling a temperature of an optical modulator comprising a heater, the method comprising:
a first operation comprising repeatedly inputting a first input signal and a second input signal to the optical modulator, inputting a heater control value to the optical modulator by sweeping the heater control value within a preset range, and obtaining an optimal heater control value at which a difference between a first output signal output from the optical modulator corresponding to the first input signal and a second output signal output from the optical modulator corresponding to the second input signal is maximized;
a second operation comprising controlling the heater using the optimal heater control value, and inputting a third input signal to the optical modulator to set a third output signal corresponding to the third input signal as a reference value; and
a third operation comprising feedback-controlling the heater control value so that a fourth output signal corresponding to a fourth input signal input to the optical modulator corresponds to the reference value.

2. The method of claim 1, wherein the first input signal and the second input signal are digital signals each having N bits, where N is an even number, and
wherein a number of transition of the first input signal and a number of transition of the second input signal are N/2.

3. The method of claim 1, wherein the third input signal is a digital signal having N bits, where N is an even number, and
wherein a proportion of 1 included in the third input signal and a proportion of 0 included in the third input signal are 50%.

4. The method of claim 1, further comprising, in the third operation, performing proportional-integral-differential (PID) control by combining the reference value with the fourth output signal, and adjusting the heater control value based on a result of the PID control.

5. The method of claim 1, further comprising, in the third operation, performing dithering on the heater control value.

6. A device configured to control a temperature of an optical modulator comprising a heater, the device comprising:
a processor configured to:
obtain an optimal heater control value at which optical modulation amplitude (OMA) of the optical modulator is maximized;
control the heater using the optimal heater control value;
input a third input signal to the optical modulator to set a third output signal corresponding to the third input signal as a reference value; and
feedback-control the optimal heater control value so that a fourth output signal corresponding to a fourth input signal input to the optical modulator corresponds to the reference value.

7. The device of claim 6, wherein the processor is further configured to:
repeatedly input a first input signal and a second input signal to the optical modulator;
input a heater control value by sweeping within a preset range to the optical modulator; and
obtain, as the optimal heater control value, a heater control value at which a difference between a first output signal output from the optical modulator corresponding to the first input signal and a second output signal output from the optical modulator corresponding to the second input signal is maximized.

8. The device of claim 7, wherein the first input signal and the second input signal are digital signals having N bits, where N is an even number, and
wherein a number of transition of the first input signal and a number of transition of the second input signal are N/2.

9. The device of claim 6, wherein the third input signal is a digital signal having N bits, where N is an even number, and
wherein a proportion of 1 included in the third input signal and a proportion of 0 included in the third input signal are 50%.

10. The device of claim 6, wherein the processor is further configured to perform proportional-integral-differential (PID) control by combining the reference value with the fourth output signal, and adjust the heater control value based on a result of the PID control.

11. The device of claim 6, wherein the processor is further configured to perform dithering on the heater control value.

12. The device of claim 6, further comprising a photodiode configured to convert an optical signal modulated by the optical modulator into an electrical signal and output the electrical signal.

13. The device of claim 12, further comprising a low pass filter (LPF) configured to filter a signal of a frequency less than or equal to a cutoff frequency by attenuating a signal of a frequency equal to or greater than the cutoff frequency, with respect to the electrical signal obtained by the photodiode.

14. An optical link device comprising:
a laser configured to output a first optical signal;
an optical transmitter configured to receive the first optical signal output by the laser and transmit a modulated second optical signal;
an optical receiver configured to receive the modulated second optical signal from the optical transmitter and restore data included in the modulated second optical signal to perform an optical link; and
an optical fiber portion between the optical transmitter and the optical receiver to transmit the modulated second optical signal from the optical transmitter to the optical receiver,
wherein the optical transmitter comprises:
an optical modulator comprising a heater and configured to modulate the first optical signal into the modulated second optical signal comprising the data; and
a temperature control device configured to:
obtain an optimal heater control value at which optical modulation amplitude (OMA) of the optical modulator is maximized;
control the heater using the optimal heater control value;
input a third input signal to the optical modulator to set a third output signal corresponding to the third input signal as a reference value; and
feedback-control the heater control value so that a fourth output signal corresponding to a fourth input signal input to the optical modulator corresponds to the reference value.

15. The optical link device of claim 14, wherein the optical transmitter comprises:
a driver configured to input data to the optical modulator; and
a high pass filter configured to filter a signal of a frequency equal to or greater than a cutoff frequency by attenuating a signal of a frequency equal to or less than the cutoff frequency, with respect to data output by the driver.

16. The optical link device of claim 14, wherein the temperature control device is further configured to:
repeatedly input a first input signal and a second input signal to the optical modulator;
input a heater control value by sweeping within a preset range to the optical modulator; and
obtain, as the optimal heater control value, a heater control value at which a difference between a first output signal output from the optical modulator corresponding to the first input signal and a second output signal output from the optical modulator corresponding to the second input signal is maximized.

17. The optical link device of claim 16, wherein the first input signal and the second input signal are digital signals having N bits, where N is an even number, and
wherein a number of transition of the first input signal and a number of transition of the second input signal are N/2.

18. The optical link device of claim 14, wherein the third input signal is a digital signal having N bits, where N is an even number, and
wherein a proportion of 1 included in the third input signal and a proportion of 0 included in the third input signal are 50%.

19. The optical link device of claim 14, wherein the temperature control device is further configured to perform proportional-integral-differential (PID) control by combining the reference value with the fourth output signal, and adjust the heater control value based on a result of the PID control.

20. The optical link device of claim 14, wherein the temperature control device is further configured to perform dithering on the heater control value.
